(19) United States
(12) Patent Application Publication
(10) Pub. No.: US 2014/0286502 A1
(43) Pub. Date: Sep. 25, 2014

(54) Audio Playback System and Method Used in Handheld Electronic Device

(71) Applicant: HTC Corporation, Taoyuan City (TW)

(72) Inventors: Jen-De Chen, Taoyuan City (TW); Chen-Yu Wang, Taoyuan City (TW); Chien-Hung Lin, Taoyuan City (TW)

(21) Appl. No.: 13/848,752

(22) Filed: Mar. 22, 2013

(51) Int. Cl. H04R 3/12

(52) U.S. Cl. CPC H04R 3/12
USPC 381/81

(57) ABSTRACT

An audio playback system used in a handheld electronic device is provided. The audio playback system comprises an audio interface, a control module, an audio processing module and at least two audio playback modules. The audio interface receives a digital audio stream. The control module generates audio channel mapping information. The audio processing module processes the digital audio stream to convert the digital audio stream to a plurality of analog audio signals and performs a channel switching process according to the audio channel mapping information. The audio playback modules output the analog audio signals after the channel switching process.

### BACKGROUND

1. Technical Field

The present invention relates to an audio playback technology. More particularly, the present invention relates to an audio playback system and method.

2. Description of Related Art

Handheld electronic devices such as smartphones and tablet PCs become the most important electronic products due to their light weight, powerful data-processing and data-transmission ability and integration of various multimedia technologies. The handheld electronic devices can playback video files or audio files by using modules related to the multimedia technology. Display modules such as screens can be used to display image thereon. Audio playback modules such as amplifiers can be used to output the sound. Therefore, the handheld electronic devices can be used for the purpose of either communication or entertainment.

The conventional handheld electronic devices can display images in different directions according to different usage scenarios, especially when the devices are rotated. Since the entertainment aspect becomes more and more important, the number of the amplifiers is increased to accomplish a better sound effect. However, if the sound field of the amplifiers of a device is generated only according to fixed positions, the best performance may not be accomplished when the device is rotated. The reproduced sound field may become unnatural since the positions of the amplifiers are different after rotation.

Accordingly, what is needed is an audio playback system and method to addresses the above issues.

### SUMMARY

An aspect of the present invention is to provide an audio playback system used in a handheld electronic device. The audio playback system comprises an audio interface, a control module, an audio processing module and at least two audio playback modules. The audio interface receives a digital audio stream. The control module generates audio channel mapping information according to a rotation angle of the handheld electronic device. The audio processing module processes the digital audio stream to convert the digital audio stream to a plurality of analog audio signals and perform a channel switching process according to the audio channel mapping information. The at least two audio playback modules output the analog audio signals after the channel switching process.

Another aspect of the present invention is to provide an audio playback method used in a handheld electronic device. The audio playback method comprises the steps outlined below. A digital audio stream is received. A rotation angle of the handheld electronic device is detected. Audio channel mapping information is generated according to the rotation angle. The digital audio stream is processed such that the digital audio stream is converted to a plurality of analog audio signals and a channel switching process is performed according to the audio channel mapping information. The analog audio signals is outputted from at least two audio playback modules after the channel switching process.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a handheld electronic device in an embodiment of the present invention;

FIG. 2 is a detailed block diagram of the audio playback system in an embodiment of the present invention;

FIG. 3A to FIG. 3C are top views of the handheld electronic device under the conditions of different rotation angles in various embodiments of the present invention;

FIG. 4A to FIG. 4D are top views of the handheld electronic device under the conditions of different rotation angles in various embodiments of the present invention;

FIG. 5A to FIG. 5C are top views of the handheld electronic device under the conditions of different rotation angles in various embodiments of the present invention;

FIG. 6 is a block diagram of an audio playback system in an embodiment of the present invention; and

FIG. 7 is a flow chart of an audio playback method in an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

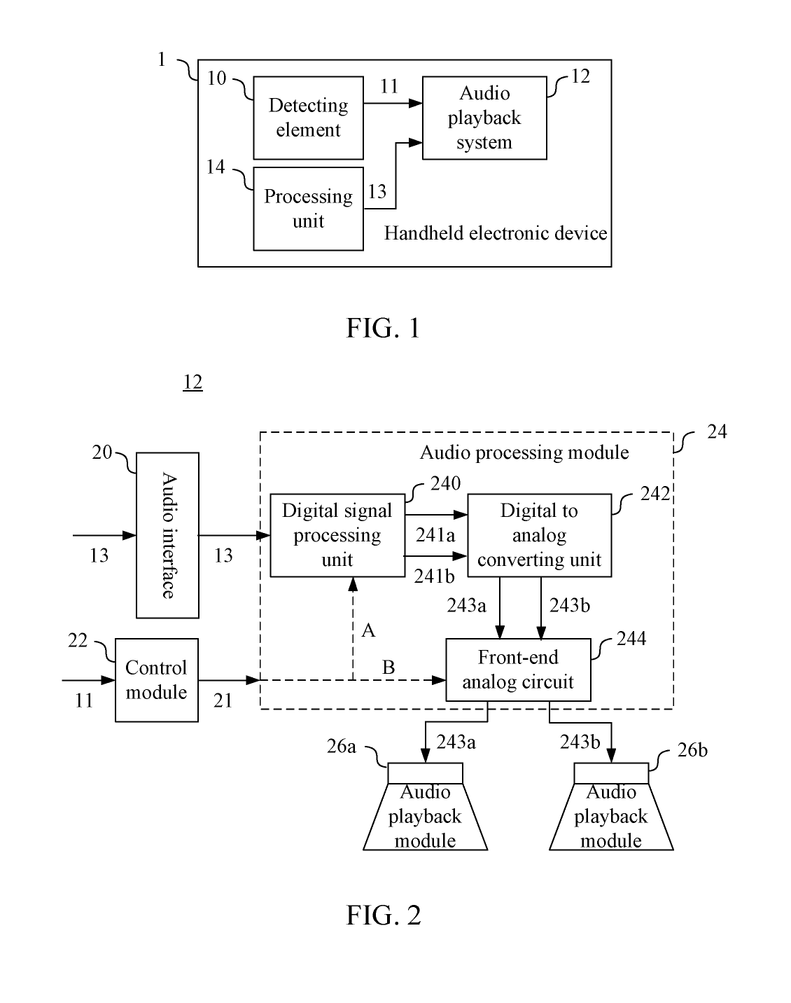

FIG. 1 is a block diagram of a handheld electronic device 1 in an embodiment of the present invention. In different embodiments, the handheld electronic device can be a smartphone, a tablet PC, a personal digital assistant or other electronic devices. The handheld electronic device 1 comprises a detecting element 10 and an audio playback system 12.

The detecting element 10 can detect a rotation angle 11 of the handheld electronic device 1. In an embodiment, the detecting element 10 is a G-sensor. Hence, the amount of the rotation angle of the handheld electronic device 1 depends on a direction of gravity. In other words, the rotation angle of the handheld electronic device 1 is related to the gravity direction.

The audio playback system 12 can receive and process a digital audio stream 13 to convert the digital audio stream 13 to an analog signal. The audio playback system 12 further plays back the analog signal. In an embodiment, the digital audio stream 13 is generated from a processing unit 14 such as a central processing unit included in the handheld electronic device 1. In different operation conditions, the user may rotate the handheld electronic device 1 to different directions. A dynamic adjusting mechanism to adjust the sound field of the sound signal generated by the playback system to match the position of the handheld electronic device 1 is thus unavoidable. The audio playback system 12 can use the rotation angle 11 detected by the detecting element 10 to perform dynamic adjustment of the sound field to accomplish the best performance. The detail description of the sound field adjusting mechanism is shown in the following paragraphs.

FIG. 2 is a detailed block diagram of the audio playback system 12 in an embodiment of the present invention. The audio playback system 12 comprises an audio interface 20, a control module 22, an audio processing module 24 and two audio playback modules 26a and 26b.

The audio interface 20 receives the digital audio stream 13. The digital audio stream 13 can be generated by a multimedia playback program according to the multimedia files stored in a storage module (not shown) in the handheld electronic device 1, be generated by the multimedia playback program according to the multimedia files transmitted by a network transmission module (not shown) in the handheld electronic device 1 from the network or according to the voice stream or be generated by a network communication program according to audio stream transmitted by the network transmission module in the handheld electronic device 1 from the network.

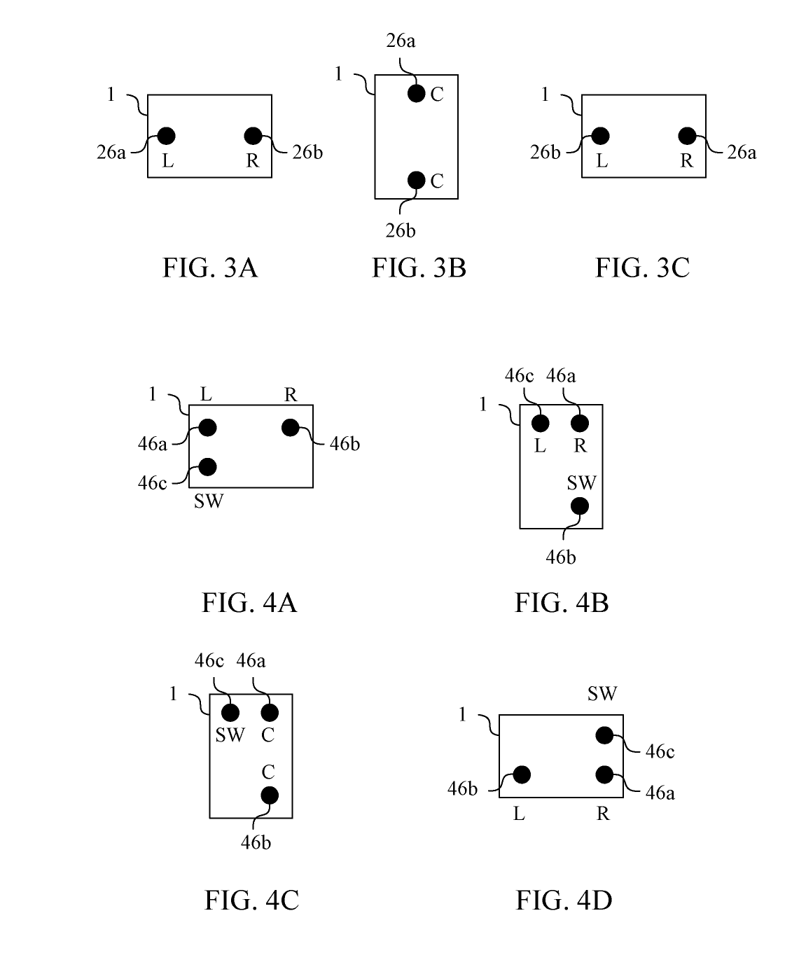

The control module 22 generates audio channel mapping information 21 according to the rotation angle 11 detected by the detecting element 10 shown in FIG. 1. Referring to FIG. 3A to FIG. 3C at the same time. FIG. 3A to FIG. 3C are top views of the handheld electronic device 1 under the conditions of different rotation angles in various embodiments of the present invention. For example, when a user holds the handheld electronic device 1 horizontally as depicted in FIG. 3A, the audio playback modules 26a and 26b can output a left channel (labeled as L in FIG. 3A) audio signal and a right channel (labeled as R in FIG. 3A) audio signal.

When the handheld electronic device 1 turns 90 degrees relative to the position shown in FIG. 3A such that it held vertically, the audio playback modules 26a and 26b are located on the same vertical direction. Consequently, the audio playback modules 26a and 26b can output the same audio signals according to the audio channel mapping information 21 such that they act as a single channel (labeled as C in FIG. 3B).

However, when the handheld electronic device 1 turns 180 degrees relative to the position shown in FIG. 3A such that it is in an opposite position, the left channel audio signal can be outputted from the audio playback module 26b and the right channel audio signal can be outputted from the audio playback module 26a according to the audio channel mapping information 21 to accomplish the sound field adjusting mechanism.

The audio processing module 24 comprises a digital signal processing unit 240, a digital to analog converting unit 242 and a front-end analog circuit 244 and receives the digital audio stream 13 from the audio interface 20 to perform processing on the digital audio stream 13. The digital signal processing unit 240 receives the digital audio stream 13 from the audio interface 20 to perform a digital signal processing, such as but not limited to decoding, on the digital audio stream 13 to generate a plurality of digital audio signals 241a and 241b corresponding to different channels (such as different audio playback modules).

The digital to analog converting unit 242 to converts the digital audio signals 241a and 241b to corresponding analog audio signals 243a and 243b. The front-end analog circuit 244 performs an analog signal processing on the analog audio signals 243a and 243b such that the analog audio signals 243a and 243b are outputted by the audio playback module 26a and the audio playback module 26b.

In different embodiments, the audio processing module 24 can perform the channel switching process according to the audio channel mapping information 21 in different processing stages. In an embodiment, the audio channel mapping information 21 is transmitted to the digital signal processing unit 240 though the path A. The digital signal processing unit 240 can perform the channel switching process on the digital audio signals 241a and 241b after the received digital audio stream 13 is decoded. For example, when the rotation angle 11 shows that the handheld electronic device 1 is under the condition shown in FIG. 3A (i.e. in a horizontal direction), the digital signal processing unit 240 allows the digital audio signal 241a that is supposed to be in the left channel to be transmitted to the audio playback module 26a after the digital to analog conversion. On the other hand, the digital signal processing unit 240 allows the digital audio signal 241b that is supposed to be in the right channel to be transmitted to the audio playback module 26b after the digital to analog conversion.

When the rotation angle 11 shows that the handheld electronic device 1 is under the condition shown in FIG. 3B, i.e. in a vertical direction such that the audio playback modules 26a and 26b are located on the same vertical direction, the digital signal processing unit 240 allows the audio playback modules 26a and 26b to output two identical signals to accomplish the single channel mode. The identical signals can be generated by such as, but not limited to, averaging the digital audio signals 241a and 241b and performing the digital to analog conversion on the averaged signals.

When the rotation angle 11 shows that the handheld electronic device 1 is under the condition shown in FIG. 3C (i.e. an up side down position), the digital signal processing unit 240 allows the digital audio signal 241a that is supposed to be in the left channel to be transmitted to the audio playback module 26b after the digital to analog conversion. On the other hand, the digital signal processing unit 240 allows the digital audio signal 241b that is supposed to be in the right channel to be transmitted to the audio playback module 26a after the digital to analog conversion.

In another embodiment, the audio channel mapping information 21 is transmitted to the front-end analog circuit 244 though the path B. The digital signal processing unit 240 can merely perform encoding process or other digital signal processes such that the digital signals are converted to the analog audio signals 243a and 243b by the digital to analog converting unit 242. Subsequently, the front-end analog circuit 244 performs the channel switching process on the analog audio signals 243a and 243b. In an embodiment, the front-end analog circuit 244 may include a plurality of switches (not shown) to transmit the analog audio signals 243a and 243b to the corresponding audio playback modules 26a and 26b after receiving the analog audio signals 243a and 243b. For example, when the rotation angle 11 shows that the handheld electronic device 1 is under the condition shown in FIG. 3A (i.e. in a horizontal direction), the front-end analog circuit 244 allows the analog audio signal 243a that is supposed to be in the left channel to be transmitted to the audio playback module 26a through the switches according to the audio channel mapping information 21. On the other hand, the front-end analog circuit 244 allows the analog audio signal 243b that is supposed to be in the right channel to be transmitted to the audio playback module 26b through the switches.

When the rotation angle 11 shows that the handheld electronic device 1 is under the condition shown in FIG. 3B, i.e. in a vertical direction such that the audio playback modules 26a and 26b are located on the same vertical direction, the front-end analog circuit 244 allows the audio playback modules 26a and 26b to output two identical signals to accomplish the single channel mode. The identical signals can be generated by such as, but not limited to, averaging the analog audio signals 243a and 243b and can be transmitted through the switches.

When the rotation angle 11 shows that the handheld electronic device 1 is under the condition shown in FIG. 3C (i.e. an up side down position), the front-end analog circuit 244 allows the analog audio signal 243a that is supposed to be in the left channel to be transmitted to the audio playback module 26b after the digital to analog conversion. On the other hand, the front-end analog circuit 244 allows the analog audio signal 243b that is supposed to be in the right channel to be transmitted to the audio playback module 26a after the digital to analog conversion.

Hence, the handheld electronic device 1 can detect the rotation angle 11 by using the detecting element 10 to obtain its operation condition. The channel switching mechanism of the audio processing module 24 can accomplish the best performance of the sound field of the audio signals generated by the audio playback modules 26a and 26b.

It is noted that in other embodiments, the number of the audio playback modules can be adjusted according to different application scenarios and is not limited by the present embodiment.

FIG. 4A to FIG. 4D are top views of the handheld electronic device 1 under the conditions of different rotation angles in various embodiments of the present invention. In the present embodiments, there are three audio playback modules 46a, 46b and 46c in the audio playback system of the handheld electronic device 1. Hence, the handheld electronic device 1 is equipped with an audio playback system of 2.1 channels.

When the handheld electronic device 1 is under the condition shown in FIG. 4A (i.e. in a horizontal direction), the audio playback module 46a can output the left channel signal (L), the audio playback module 46b can output right channel signal (R) and the audio playback module 46c can output subwoofer channel signal (SW).

When the handheld electronic device 1 is under the condition shown in FIGS. 4B and 4C (i.e. in a vertical direction), there can be various possible methods to realize the channel switching mechanism. In an embodiment, the audio playback modules 46a and 46c can output the right channel signal (R) and left channel signal (L) respectively and the audio playback module 46b can output the subwoofer channel signal (SW), as shown in FIG. 4B. In another embodiment, the audio playback modules 46a and 46b can both output identical signals to act as a single channel (C), and the audio playback modules 46c can output the subwoofer channel signal (SW), as shown in FIG. 4C.

When the handheld electronic device 1 is under the condition shown in FIG. 4D (i.e. an up side down position), the audio playback module 46b can output the left channel signal (L), the audio playback module 46a can output right channel signal (R) and the audio playback module 46c can output subwoofer channel signal (SW).

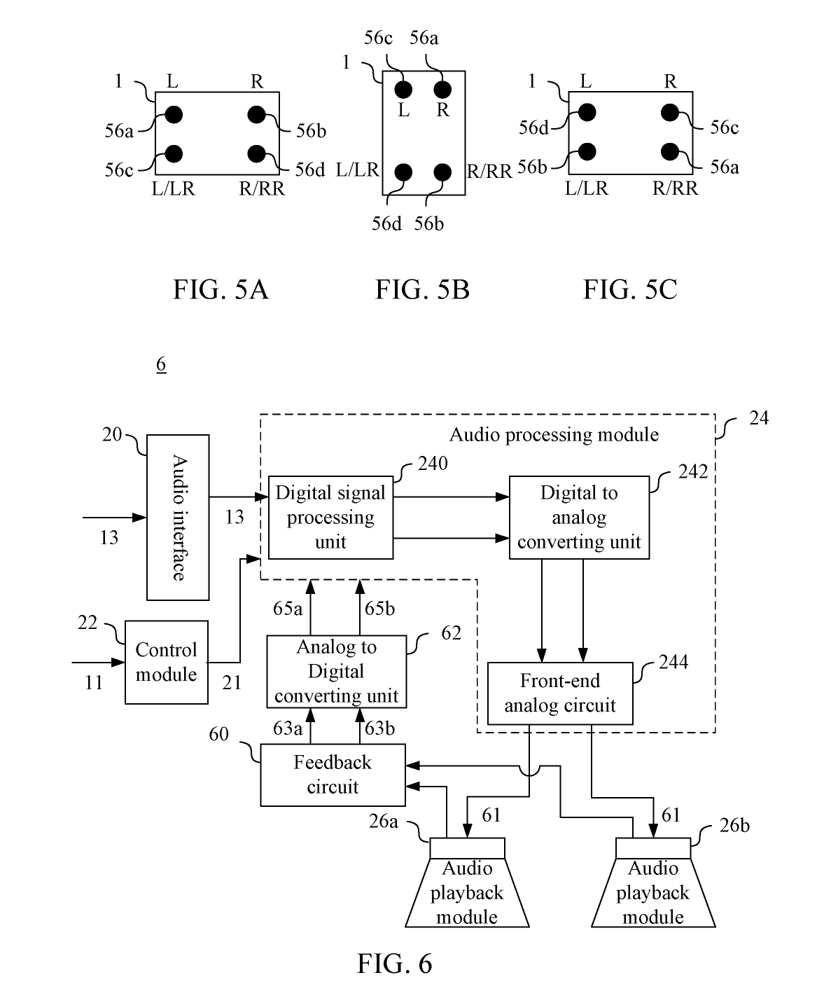

FIG. 5A to FIG. 5C are top views of the handheld electronic device 1 under the conditions of different rotation angles in various embodiments of the present invention. In the present embodiments, there are four audio playback modules 56a, 56b, 56c and 56d in the audio playback system of the handheld electronic device 1. Hence, the handheld electronic device 1 is equipped with an audio playback system of 4 channels including a left channel, a right channel, a left rear channel, and a right rear channel.

When the handheld electronic device 1 is under the condition shown in FIG. 5A (i.e. in a horizontal direction), the audio playback modules 56a, 56b, 56c and 56d can output the right channel signal, the left channel signal, the left or the left rear channel signal and the right or the right rear signal respectively. When the handheld electronic device 1 is under the condition shown in FIG. 5B (i.e. in a vertical direction), the audio playback modules 56a, 56b, 56c and 56d can output the right channel signal, the right or the right rear channel signal, the left channel signal and the left or the left rear channel signal respectively. When the handheld electronic device 1 is under the condition shown in FIG. 5C (i.e. an up side down position), the audio playback modules 56a, 56b, 56c and 56d can output the right or the right rear channel signal, the left or the left rear channel signal, the right channel signal and the left channel signal respectively.

FIG. 6 is a block diagram of an audio playback system 6 in an embodiment of the present invention. The elements in the audio playback system 6 are similar to those in the audio playback system 12 depicted in FIG. 2. Therefore, the identical elements are not described herein. In the present embodiment, the audio playback system 6 further comprises a feedback circuit 60 and an analog to digital converting unit 62. When the amount of the audio playback modules in the audio playback system 6 is unknown, the feedback circuit 60 and the analog to digital converting unit 62 can be used to determine the amount of the audio playback modules.

The feedback circuit 60 generates a plurality of analog feedback signals 63a and 63b when the audio processing module 24 transmits a test audio signal 61 to the audio playback modules 26a and 26b. The analog to digital converting unit 62 converts the analog feedback signals 63a and 63b to digital feedback signals 65a and 65b. The audio processing module 24 determines an amount of the audio playback modules 26a and 26b according to the digital feedback signals 65a and 65b. The values of the analog feedback signals 63a and 63b are related to resistances of the audio playback modules 26a and 26b. When one of the audio playback modules 26a and 26b does not function normally or is disconnected from the other components of the audio playback system, the analog feedback signal generated correspondingly becomes infinitely large such that the converted digital feedback signal is infinitely large as well. Therefore, the amount of the audio playback modules in the audio playback system that can really work can be determined according to the number and the value of the feedback signals.

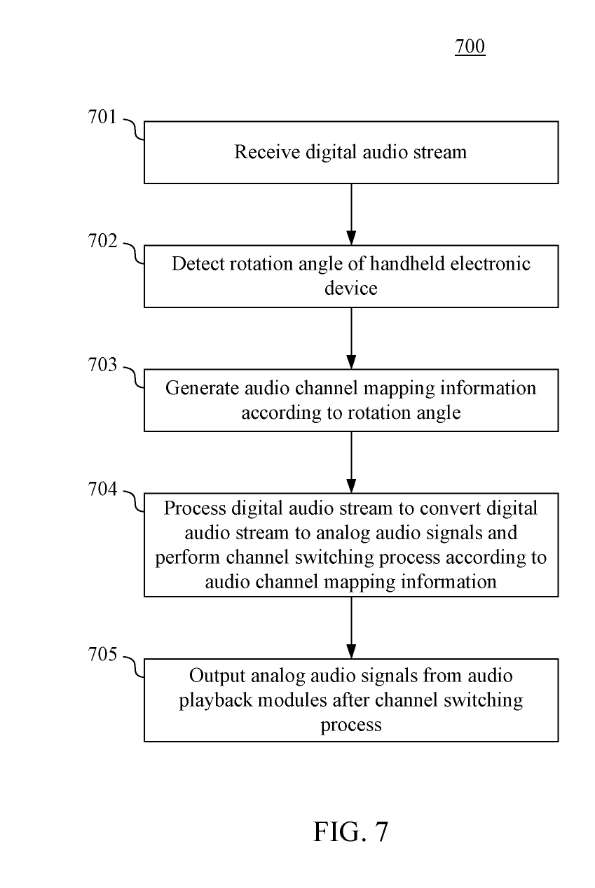

FIG. 7 is a flow chart of an audio playback method 700 in an embodiment of the present invention. The audio playback method 700 can be used in the audio playback system 12 in the handheld electronic device 1 depicted in FIG. 1. The audio playback method 700 comprises the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 701, the audio interface 12 of the audio playback system 12 receives the digital audio stream 13.

In step 702, the detecting element 10 detects the rotation angle 11 of the handheld electronic device 1.

In step 703, the control module 22 generates the audio channel mapping information 21 according to the rotation angle 11.

In step 704, the audio processing module 24 processes the digital audio stream 13 such that the digital audio stream 13 is converted to analog audio signals 243a and 243b and the channel switching process is performed according to the audio channel mapping information 21.

In step 705, the audio playback modules 26a and 26b output the analog audio signals 243a and 243b after the channel switching process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An audio playback system used in a handheld electronic device, wherein the audio playback system comprises:
an audio interface to receive a digital audio stream;
a control module to generate audio channel mapping information according to a rotation angle of the handheld electronic device;
an audio processing module to process the digital audio stream in order to convert the digital audio stream to a plurality of analog audio signals and to perform a channel switching process according to the audio channel mapping information; and
at least two audio playback modules to output the analog audio signals after the channel switching process.

2. The audio playback system of claim 1, wherein the audio processing module comprises:
a digital signal processing unit to perform a digital signal processing on the digital audio stream to generate a plurality of digital audio signals;
a digital to analog converting unit to convert the plurality of digital audio signals to the plurality of analog audio signals; and
a front-end analog circuit to perform an analog signal processing on the plurality of analog audio signals.

3. The audio playback system of claim 2, wherein the digital signal processing unit performs the channel switching process on the plurality of digital audio signals according to the audio channel mapping information such that the at least two audio playback modules output the analog audio signals after the digital to analog converting unit converts the plurality of switched digital audio signals to the analog audio signals and the front-end analog circuit performs the analog signal process on the analog audio signals.

4. The audio playback system of claim 2, wherein the front-end analog circuit further performs the channel switching process on the plurality of analog audio signals according to the audio channel mapping information such that the at least two audio playback modules output the switched analog audio signals.

5. The audio playback system of claim 1, further comprising:
a feedback circuit to generate a plurality of analog feedback signals when the audio processing module transmits a test audio signal to the at least two audio playback modules; and
an analog to digital converting unit to convert the plurality of analog feedback signals to a plurality of digital feedback signals;
wherein the audio processing module determines an amount of the at least two audio playback modules according to the plurality of digital feedback signals.

6. The audio playback system of claim 5, wherein the values of the plurality of analog feedback signals are related to resistances of the at least two audio playback modules.

7. An audio playback method used in a handheld electronic device, wherein the audio playback method comprises:
receiving a digital audio stream;
detecting a rotation angle of the handheld electronic device;
generating audio channel mapping information according to the rotation angle;
processing the digital audio stream to convert the digital audio stream to a plurality of analog audio signals and performing a channel switching process according to the audio channel mapping information; and
outputting the analog audio signals from at least two audio playback modules after the channel switching process.

8. The audio playback method of claim 7, wherein the step of processing the digital audio stream further comprises:
performing a digital signal processing on the digital audio stream to generate a plurality of digital audio signals;
converting the plurality of digital audio signals to the plurality of analog audio signals; and
performing an analog signal processing on the plurality of analog audio signals.

9. The audio playback method of claim 8, further comprising performing the channel switching process on the plurality of digital audio signals according to the audio channel mapping information such that the at least two audio playback modules output the analog audio signals after the plurality of digital audio signals are converted to the analog audio signals and the analog signal process is performed on the analog audio signals.

10. The audio playback method of claim 8, further comprising performing the channel switching process on the plurality of analog audio signals according to the audio channel mapping information such that the at least two audio playback modules output the switched analog audio signals.

11. The audio playback method of claim 7, further comprising:
transmitting a test audio signal to the at least two audio playback modules to generate a plurality of analog feedback signals; and
converting the plurality of analog feedback signals to a plurality of digital feedback signals; and
determining an amount of the at least two audio playback modules according to the plurality of digital feedback signals.

12. The audio playback method of claim 11, wherein the values of the plurality of analog feedback signals are related to resistances of the at least two audio playback modules.

13. The audio playback method of claim 7, wherein the step of detecting the rotation angle further comprises detecting the rotation angle of the handheld electronic device with respect to a gravity direction.
